(19) United States
(12) Patent Application Publication
(10) Pub. No.: US 2006/0213017 A1
(43) Pub. Date: Sep. 28, 2006

(54) Reinforced handle for a cleaning system

(76) Inventors: Russell Bele, Pleasanton, CA (US); Douglas Minkler, Pleasanton, CA (US); Amy Crandall, Pleasanton, CA (US)

Correspondence Address: THE CLOROX COMPANY, P.O. BOX 24305, OAKLAND, CA, 94623-1305, US

(21) Appl. No.: 11/093,215

(22) Filed: Mar. 28, 2005

(51) Int. Cl. A46B 5/00; B25G 1/00

(52) U.S. Cl. 15/143.1

(57) ABSTRACT

A reinforced handle comprising a handle housing with one or more support ribs positioned on the inside surface of the handle housing and a reinforcing insert positioned adjacent to the support ribs, wherein the reinforcing insert has a preferable shape selected from one of the following group of an elongated bar with a U-shaped channel, a rod with a U-shaped channel, or a hollow cylinder. The reinforced handle can be used with a cleaning system containing a cleaning head assembly.

### BACKGROUND OF THE INVENTION

Cleaning devices and systems for use in the home, industrially or otherwise include a broad range of technology. With regard to hand-held, mop-like devices used by an individual, the prior art is replete with variations. Conventional floor, ceiling, wall or other surface mops typically have a rigid, elongated handle portion, the handle having a proximal and a distal end. The handle portion is held closer to the proximal end, while a cleaning head is. placed at the distal end of the handle. Typically, mop heads for use indoors are about 3-4 inches wide and about 9-12 inches long, and have a removable sponge or other type absorbent pad portion. As is well known, once a cleaning pad becomes worn out or soiled beyond utility, it is removed and replaced with a fresh cleaning pad.

Typically, a mop head is dipped into a pail or bucket containing water and a cleaning agent. The mop head is wrung out so as not to deposit too great an amount of cleaning fluid on the surface being cleaned. It would be highly useful to provide a hand-held mopping system with an on-board, disposable, rechargeable or replaceable fluid reservoir.

U.S. Pat. No. 5,071,489 issued Dec. 10, 1991 to Silvenis et al. teaches a floor cleaner using disposable sheets. The apparatus comprises a handle portion pivotally attached to a cleaning head member with a flat lower surface. The lower surface of the member has frictional means thereon which are intended to maintain a pre-moistened fabric sheet between the surface and an area to be cleaned. The frictional means are a series of raised portions, etc.

U.S. Pat. No. 5,609,255 issued Mar. 11, 1997 to Nichols teaches a washable scrubbing mop head and kit. The device and system contains a multi-part handle, head portion, and an attachable sponge mop pad.

U.S. Pat. No. 5,888,006 issued Mar. 30, 1999 to Ping et al. teaches a cleaning implement having a sprayer nozzle attached to a cleaning head member. Cleaning fluid sprays out of a sprayer nozzle portion attached to a cleaning head mounted at the base of a handle portion, the head portion mounted to the handle portion with a universal joint.

U.S. Pat. No. 5,953,784 issued Sep. 21, 1000 to Suzuki et al. teachers a cleaning cloth and cleaning apparatus. The apparatus includes a handle with a front, flat head section for insertion into a bag-like cleaning cloth.

U.S. Pat. No. 5,988,920 issued Nov. 23, 1999 to Kunkler et al. teaches a cleaning implement having a protected pathway for a fluid transfer tube. The cleaning implement has a fluid reservoir coupled to a dispenser with a universal joint, and a fluid transfer tube, the fluid transfer tube at least partially positioned to pass through the universal joint.

U.S. Pat. No. 6,048,123 issued Apr. 11, 2000 to Holt et al. teaches a cleaning implement having high absorbent capacity. Overall maximum fluid absorbencies, rates of absorbency, and squeeze-out rates are defined, and examples of materials which exhibit those types of behavior are provided. As best understood, these inventions are directed to the use of superabsorbent materials, and not the use of conventional, natural and synthetic materials.

A microfiber is typically, and others are included herein as well, made of a polyester/polyamide blend that has a thickness finer than 1/100 of a human hair. In the industry of fibers and fabrics, the following classifications of fibers is considered standard:

| Yarn Count | | Fiber Classification |
|---|---|---|
| >7.0 | dpf* | coarse fiber |
| 2.4-7.0 | dpf | normal fiber |
| 1.0-2.4 | dpf | fine |
| 0.3-1.0 | dpf | microfiber |
| <0.3 | dpf | ultra-microfiber |

*dpf = denier per filament
Note:
A filament with a thickness of 1 denier corresponds to a yarn length of 9,000 meters/gram. Thus, a 0.2 denier fiber corresponds to a yarn length of 45 kilometers/gram

### SUMMARY OF THE INVENTION

A reinforced handle comprising a handle housing with one or more support ribs positioned on the inside surface of the handle housing and a reinforcing insert positioned adjacent to the support ribs, wherein the reinforcing insert has a shape selected from one of the following group of an elongated bar with a U-shaped channel, a rod with a U-shaped channel, or a hollow cylinder. The reinforced handle can be used with a cleaning system containing a cleaning head assembly. A handle for a cleaning system comprising a handle housing, a trigger member connected to the handle housing, a push rod positioned inside the handle housing and coupled to the trigger member and at least one reinforcing insert positioned such that the center of the housing surrounds the push rod.

### BRIEF DESCRIPTION OF THE DRAWINGS

FIG. 1 is a representative exploded view of a preferred embodiment of a cleaning system of the present invention.

FIG. 2 is a representative cross section view of a preferred embodiment of a cleaning system of the present invention.

FIG. 3 is a representative exploded view of a preferred embodiment of a mid portion 400a of a handle sub-assembly (as shown in FIGS. 1 and 2) of a cleaning system of the present invention.

FIG. 4 is a representative isometric view of a preferred embodiment of a shaft section of a handle sub-assembly of a cleaning system of the present invention.

FIG. 5 is a representative isometric view of a preferred embodiment of a threaded shaft coupling member of a handle sub-assembly of a cleaning system of the present invention.

FIG. 6 is a representative isometric view of a preferred embodiment of a sleeve member of a handle sub-assembly of a cleaning system.

FIG. 7 is a representative view of a preferred embodiment of a push rod of a handle sub-assembly.

FIG. 8 is a representative view of a preferred embodiment of a telescoping shaft section of a handle sub-assembly (as shown in FIGS. 1 and 2) of a cleaning system.

FIG. 9 is a representative exploded view of an embodiment of a proximal end of a handle sub-assembly of a cleaning system.

FIG. 10 is a representative section view of an embodiment of a proximal end of a handle sub-assembly of a cleaning system.

FIG. 11 is a representative cross-sectional view of a preferred embodiment of a proximal end of handle sub-assembly of a cleaning system.

FIG. 12 is a representative exploded view of a preferred embodiment of a proximal end of a handle sub-assembly where the individual components are shown separately.

FIG. 13 is a detailed close-up view of the distal end of a preferred embodiment of handle sub-assembly.

FIG. 14 is a cross-sectional view of a preferred embodiment of a proximal end of a part of a handle sub-assembly of a cleaning system.

FIG. 15 is a representative view of a preferred embodiment of a fully assembled cleaning system.

### DETAILED DESCRIPTION

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications. without departing from the scope and spirit of the invention. Therefore, the invention is not intended to be limited to the embodiments disclosed, but the invention is to be given the largest possible scope, which is consistent with the principals and features described herein.

It will be understood that even though parts of different embodiments have similar functions or uses, they may have been given similar or identical reference numerals and descriptions. It will be understood that such duplication of reference numerals is intended solely for efficiency and ease of understanding the present invention, and is not to be construed as limiting in any way, or as implying that the various embodiments themselves are identical.

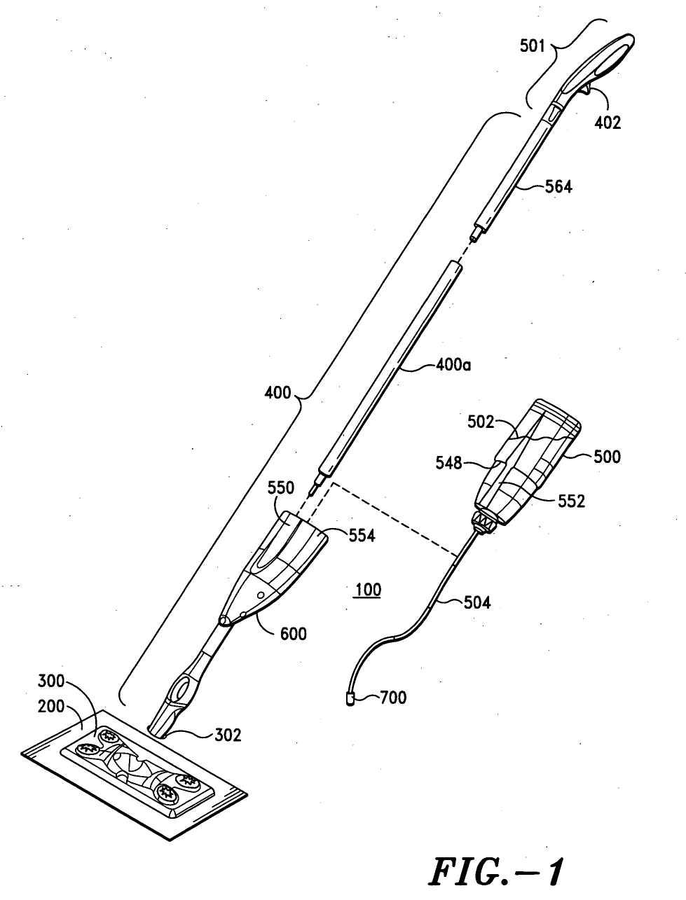

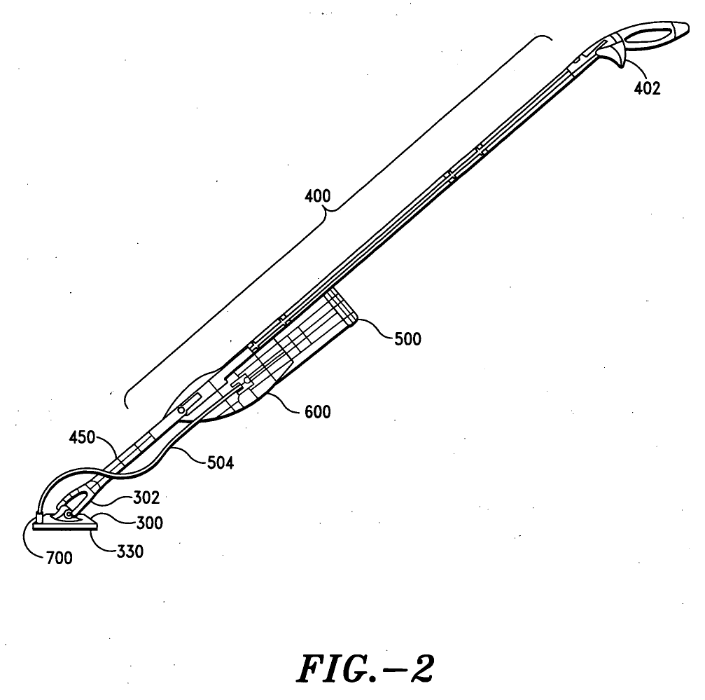

FIG. 1 is a representative exploded view of a preferred embodiment of a cleaning system 100 of the present invention. FIG. 2 is a representative cross section view of a preferred embodiment of a cleaning system 100 of the present invention. The cleaning tool 100 consists of a preferred embodiment of an absorbent cleaning pad or sheet 200, which is removably mounted onto a cleaning head assembly 300. The head sub-assembly 300 is attached via universal joint 302 to a handle sub-assembly 400. The handle sub-assembly 400 can be disassembled for easy storage or package of the cleaning tool 100. A fluid reservoir 500, which is intended to carry a liquid cleaning solution 502, can be mounted on the handle sub-assembly 400 within a suitably designed holster sub-assembly 600. The fluid reservoir 500 has a flow delivery tube 504 which leads through a yoke portion on the handle sub-assembly to a fluid nozzle sub-assembly 700 which is mounted on the cleaning head sub-assembly 300 near the leading edge of the absorbent pad or sheet 200. A trigger mechanism 402 located on the proximal end of the handle sub-assembly 400 actuates a valve system for providing flow of fluid from the fluid reservoir 500 through the nozzle sub-assembly 700.

It will be understood that the mechanical linkages described herein between the shaft sections of the handle portion 400 can all be configured to be collapsible, dis-assemblable, telescoping, bayonet mounted and linked, etc. Such adaptability for the system is designed to enhance storage, packaging, and utility of the system 100 of the present invention.

In a preferred embodiment, the handle portion 400 comprises sections, which interlock together in a bayonet-type configuration. The sections are each distinctively keyed, sized or shaped to confirm that the advanced cleaning system 100 is assembled properly. In a preferred embodiment, the system is a one-time assembly system, this precluding disassembly of the system. The shaft section 400a and others, can be a single assembly, over-torque-proof design, such as incorporating advanced, flanged or cone-shaped collars and keyed end sections, are also important and will be included within the present invention. In a preferred embodiment, the system is automatically self-adjusting, and the handle is self-aligning. The trigger draw can be set automatically, once the system is assembled.

In a preferred embodiment, the delivery tubing 504 comprises 0.25 inch inside or outside diameter plastic or rubber tubing. The internal diameter can be larger or smaller, as desired or suitable. The tubing 504 can be replaceable and/or reusable, as desired or appropriate.

FIG. 3 is a representative exploded view of a mid portion 400a of a handle sub-assembly 400 such as shown in FIGS. 1 and 2 of a cleaning system 100 of the present invention. It will be known based on the foregoing and the following that the mid portion 400a of the handle sub-assembly 400 can have various embodiments, and but essentially a single preferred embodiment is described herein. The handle sub-assembly 400 consists of a shaft section 410 with a sleeve member 420 pressed onto place at either end. Further, it will be known to those skilled in the art that additional means for securing the sleeve members 420 into the ends of the shaft sections 410 will be available,. including threaded ends, pins, welding, other types of press fittings, compression and expansion fittings or adhesives, and other common or custom coupling or attachment means, etc.

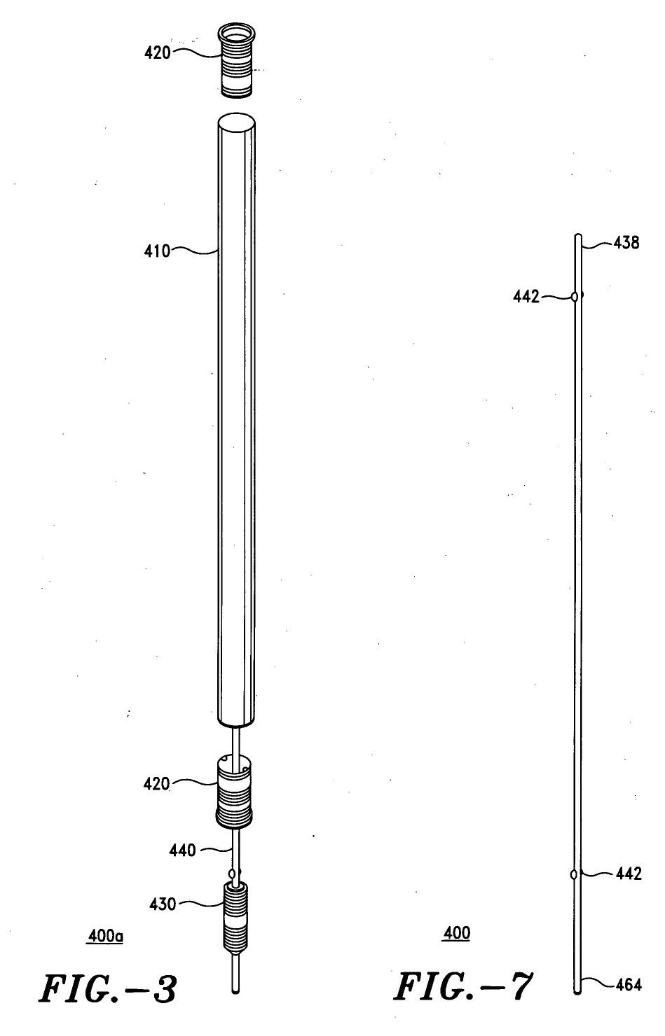

FIG. 4 is a representative isometric view of a preferred embodiment of a shaft section 410 of a handle sub-assembly 400 of a cleaning system 100 of the present invention. The tubular shaft section 410 can be formed of any of a variety of materials, including but not limited to the following materials: glass, paper, cardboard, wood, any metals including steels, aluminum, titanium, alloys including chrome, molybdenum, plastics, composites including fiber glass, formica, natural and synthetic, man-made materials, canes, tubular members made of carbon components, crystals, fibers, alloys, and combinations thereof. The tubular shaft section 410 can be formed of any of a variety of methods, including but not limited to the following methods: by extrusion, pressing, braking, rolling sheet portions, stamping, carved, otherwise shaped, formed, prepared and/or assembled, and combinations thereof.

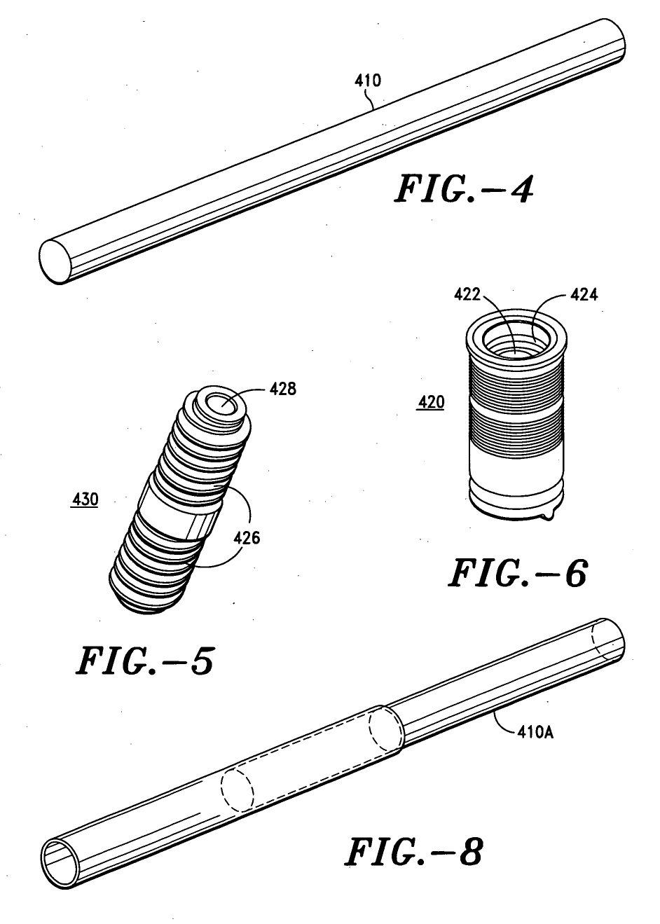

FIG. 5 is a representative isometric view of a preferred embodiment of a shaft coupling 430 of a handle sub-assembly 400 of a cleaning system 100 of the present invention. FIG. 6 is a representative isometric view of a preferred embodiment of a sleeve member 420 of a handle sub-assembly 400 of a cleaning system 100 of the present invention. The threaded shaft coupling member 430 has one or more helically threaded portions 426 which align and thread into matching threaded portion 424 in the sleeve member 420. It will be apparent, that by coupling multiple shaft sections 410 together with shaft coupling members 430 between different shaft sections 410, a handle sub-assembly 400 having essentially any desired length or other geometry may be obtained. Additionally, an opening or hole 428 extends through the coupling member 430.

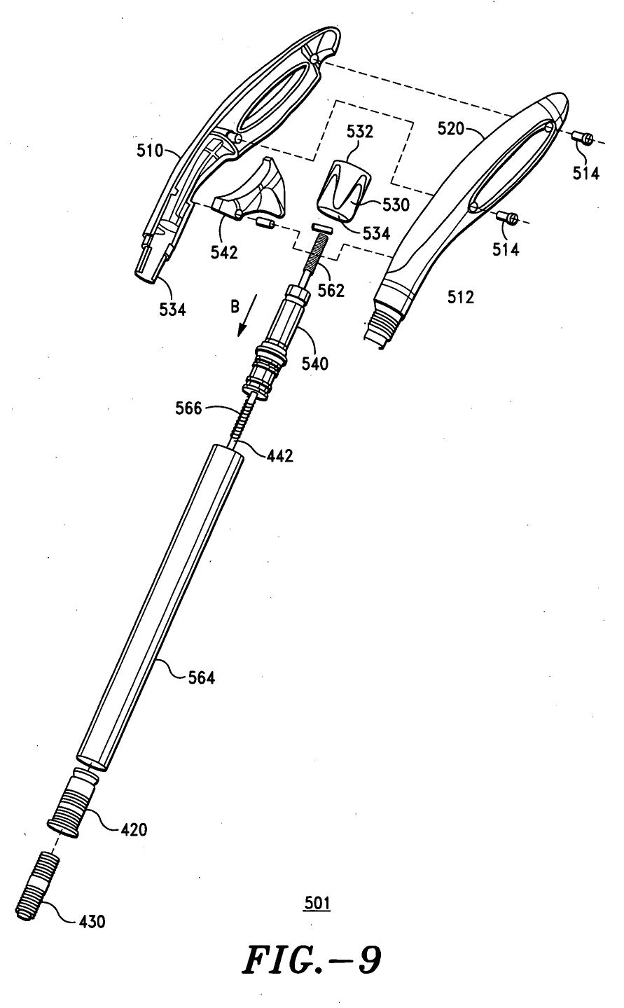

FIG. 7 is a representative view of a preferred embodiment of a push rod 440 such as of a mid-portion 400a handle sub-assembly 400 of a cleaning system 100 of the present invention. The push rod 440 extends through holes 422 passing through the sleeve members 420 and through the openings 428 through the coupling members 430. Local deformations 442 at either end of the push rod 440 serve as detents or stops for controlling translation of the push rod 440 as desired.

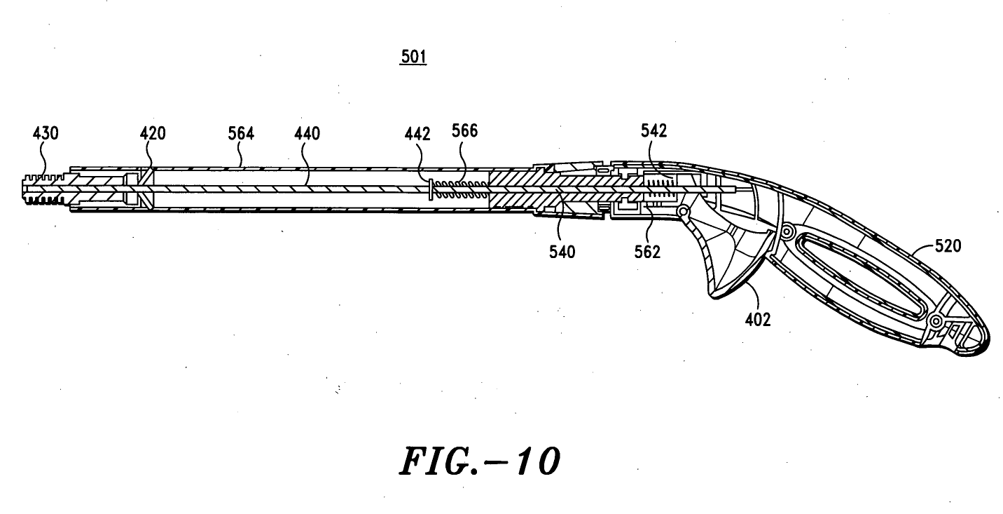

FIG. 8 is a representative view of a preferred embodiment of a telescoping shaft section 410a of a handle sub-assembly 400 (as shown in FIGS. 1 and 2) of a cleaning system 100 of the present invention.

It will be understood by the foregoing and the following that the handle sub-assembly 400 of a cleaning system 100 can comprise one or more shaft sections 410 in a coupled, hinged, telescoping, collapsible, expanding or other configuration. A plurality of telescoping or collapsing shaft sections 410 in combination is space saving, convenient to use and economical to manufacture, and is included within the scope of the present invention.

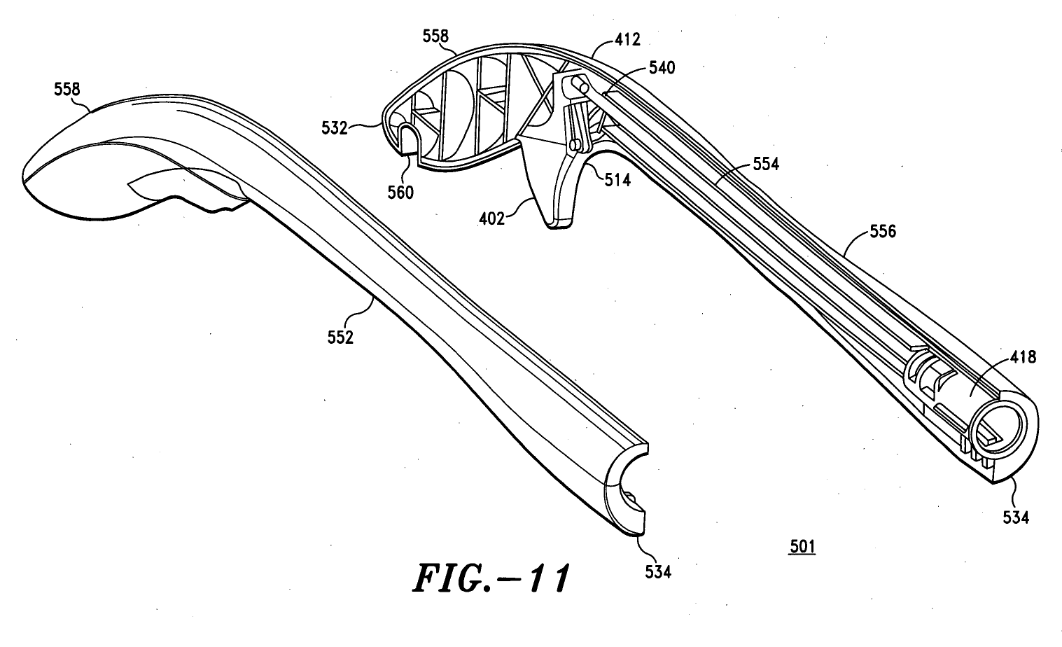

FIG. 9 is a representative exploded view of an embodiment of a proximal end 501 of a handle sub-assembly 400 of a cleaning system 100 of the present invention. FIG. 10 is a representative section view of an embodiment of a proximal end 501 of a handle sub-assembly 400 of a cleaning system 100 of the present invention.

As shown, the right handle portion 510 couples with the left handle portion 512 through detachable or permanent mating means 514. Together with an optional overmolded portion 520, the three sections form an ergonomic hand grip for the distal end 500 of the handle assembly 400. As shown, trigger member 402 is retained within the assembly 500 with trigger pin 560. First spring means 562 biases the trigger in a set position.

As shown, upper portion 532 of the collar portion 530 engages the distal ends 534 of right and left handle portions 510 and 512, respectively. Thus, handle coupling 540 is retained between the collar 530 and the right and left handle portions 510 and 512, respectively, and slides within proximal shaft portion 564. Push rod 440 extends through handle coupling 540 and proximal shaft portion 564. Second spring means 566 is positioned over the pull rod 440 retained in position between slide stop 442. At a distal end, shaft sleeve 420, as shown in FIGS. 3 and 6, couples to proximal shaft portion 564, with shaft coupling member 430 threadingly engaged thereto, as shown in FIGS. 3 and 5.

As trigger 402 is squeezed manually or otherwise, bearing surface 542 on trigger 402 bears thrustingly upon proximal end 544 of handle coupling 540 to drive the handle coupling 540 distally in direction B. The distal end 546 of handle coupling 540 bears upon push rod 440 through second spring means 566. In a preferred embodiment, the handle assembly 501 is automatically self-adjusting. Upon initial assembly, a first draw on the trigger 402 sets the correct distances for trigger travel as it translates to activation of the valve assembly 800 on the reservoir 500. The action is a modified ratchet mechanism as found on caulking guns and other extrusion or pump devices.

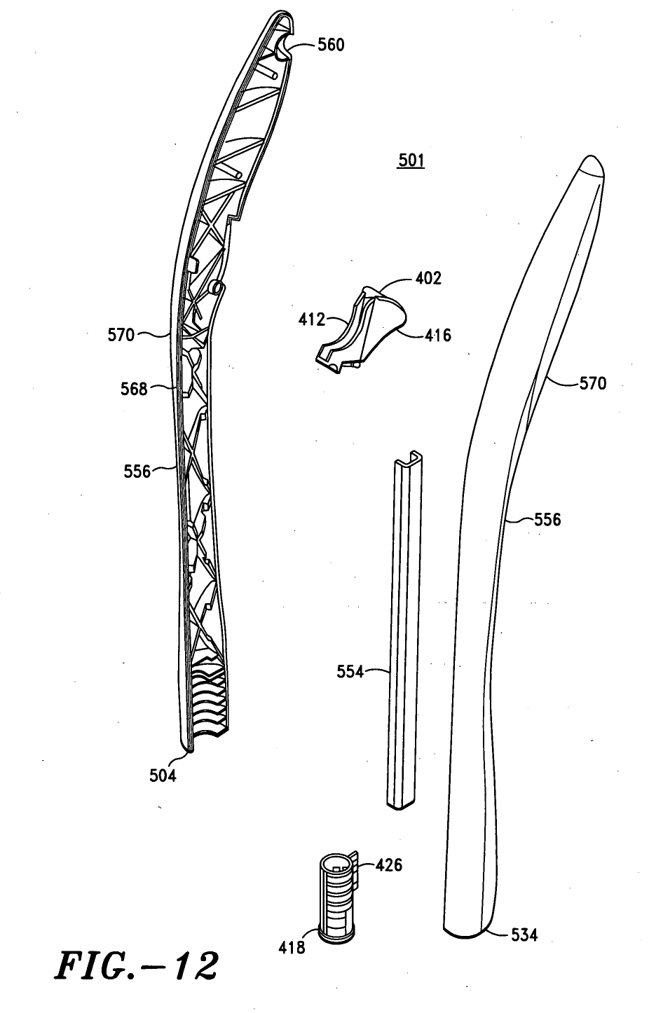

FIG. 11 is a representative cross-sectional view of an embodiment of a proximal end 501 of a preferred handle sub-assembly 400 of a cleaning system 100 of the present invention. Right hand portion 552 and left hand portion 556 of the handle sub-assembly may be detachably connected to one another by one or more mating means 514 such as screws, pins, snaps, tabs, flanges, and other connection means known in the art. Alternatively, the right hand and left hand portions of the handle may also be permanently connected using techniques such as ultrasonic welding, overmolding, applying adhesive, combinations thereof or other means of permanent attachment that are known in the art.

The method for making a handle for the cleaning system requires: creating one or more handle housing portions, inserting a trigger member 402 connected to a pushrod 540 between the handle housing portions and joining the handle housing portions together. As shown in FIG. 11, the handle housing may have a. right hand portion 552 and left hand portion 556 which are joined together by ultrasonic welding, an adhesive, an overmold or combinations thereof.

At the proximal end 532 of the right and left handle portions is an ergonomic hand grip portion 558 of the handle. The ergonomic hand grip portion 558 includes a hook member 560, which allows the cleaning system 100 to be neatly hung and put away when not in use. As shown, trigger member 402 is retained within the assembly 500 and coupled to the push rod 540, which extends from the trigger member 402 to the distal end 534 of the handle. When the trigger is squeezed, the top portion of the trigger member 412 contacts the push rod 540 which in turn translates into activation of the valve assembly 800 which releases fluid from the reservoir 500 down to the cleaning head assembly 300.

A reinforcing insert material 554 is positioned adjacent to the push rod 540. The insert material 554 may be in the shape of an elongated rod with a U-shaped channel, a bar with a U-shaped channel or a hollow cylinder. The preferred reinforcing insert material is substantially straight. The reinforcing insert material is preferably a metal and most preferably, steel. In a preferred embodiment of the invention, the reinforcing insert material is positioned below the ergonomic hand grip portion 558 and above the sleeve member 418 at the distal end of the handle 534. The sleeve member 418 provides a means to securely attach the proximal end 501 to the rest of the preferred handle sub-assembly 400 of the cleaning system.

FIG. 12 is a representative exploded view of a preferred embodiment of a proximal end 501 of a handle sub-assembly 400 where the individual components are shown separately. The right hand portion 552 and left hand portion 556 of the handle sub-assembly are shown separated to fully show the support ribs 568 on the inside of the housing 570 of the handle. The housing 570 and support ribs 568 are preferably made of a rigid plastic, most preferably a polycarbonate plastic or acrylonitrile butadiene styrene plastic (ABS plastic). The support ribs 568 may have numerous designs, including but not limited to, perpendicular semi-circular plates or crisscross pattern plates to provide tensional and transverse stiffness to the housing 570.

The trigger member 402 fits into the housing 570 such that when the right and left hand portions of the handle are fitted together, the bottom half of the trigger member 416 extends below the housing to hide the top portion of the trigger member 412. The insert material 554 may be configured with any shape and cross-section geometry that fits inside the structure of the housing 570. In a preferred embodiment of the invention, the insert material 554 is in the shape of a bar with a U-shaped channel and the bar is positioned on the inside of the housing 570.

The support ribs 568 and the insert material 554 allow the handle sub-assembly to be strong and durable while remaining lightweight and easy for a user to hold and maneuver. In addition, the use of support ribs 568 and insert material 554 add structural strength to the handle and uses less materials in manufacturing than a similar solid handle. The use of less materials in manufacturing than a similar solid handle makes the handle more cost effective to manufacture, ship and package. The insert material 554 is preferably designed to fit snugly in the spaces provided by the he support ribs 568 so that the two work together to provide the maximum amount of rigidity to the handle sub-assembly 400.

A sleeve member 418 is positioned at the distal end 534 of the handle below the insert material 554. The sleeve member 418 has a fin member 426, which allows the sleeve 418, and a shaft coupling member 430, as shown in FIG. 5, to rotatably screw and lock into place with a bayonet-type mount. The mechanical linkages between of the shaft section and the proximal end of the handle 501 can all be configured in various ways to be collapsible, dis-assemblable, telescoping, bayonet mounted and linked, etc. Such adaptability for the system is designed to enhance storage, packaging, and utility of the system 100 of the present invention.

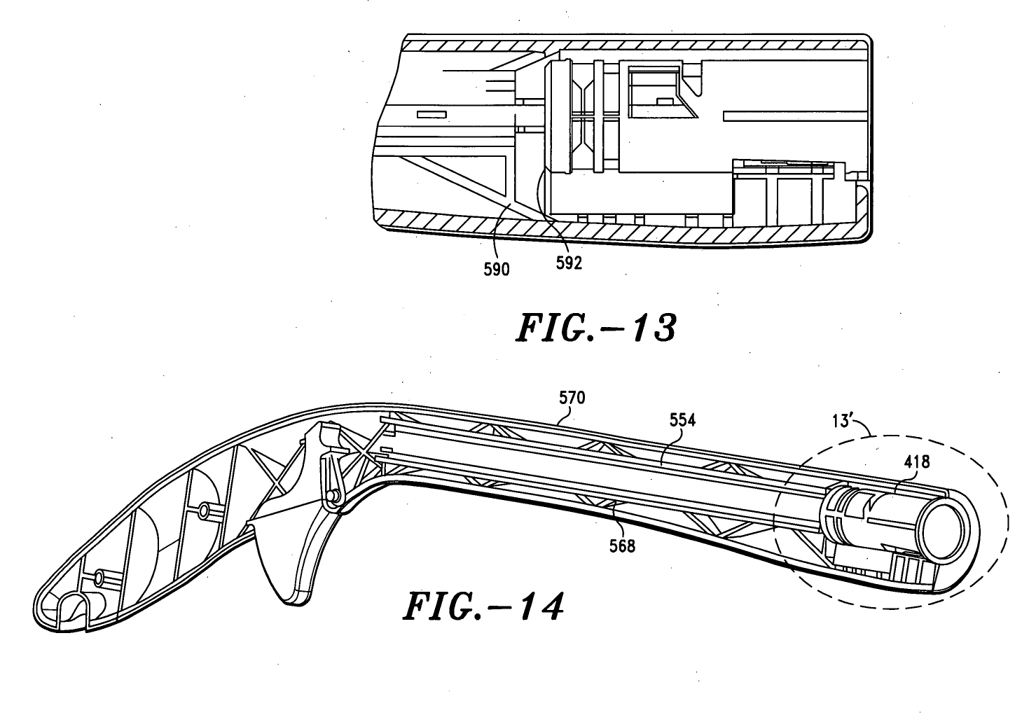

FIGS. 13 and 14 are cross-sectional views of a preferred embodiment of a proximal end 501 of a handle sub-assembly 400 of a cleaning system 100 of the present invention. FIG. 14 shows the left handle portion 556 with a detailed view of the distal end 534 of the handle. The dotted line 13′ indicates the section of FIG. 14 that was used to create the detailed view shown in FIG. 13. FIG. 13 clearly shows the reinforcing insert material 554 where the bottom edge of the insert 590 is spaced away from the top edge of the sleeve 592. The reinforcing insert material does not rest on the sleeve 418, but is held in place by the housing 570 and support ribs 568.

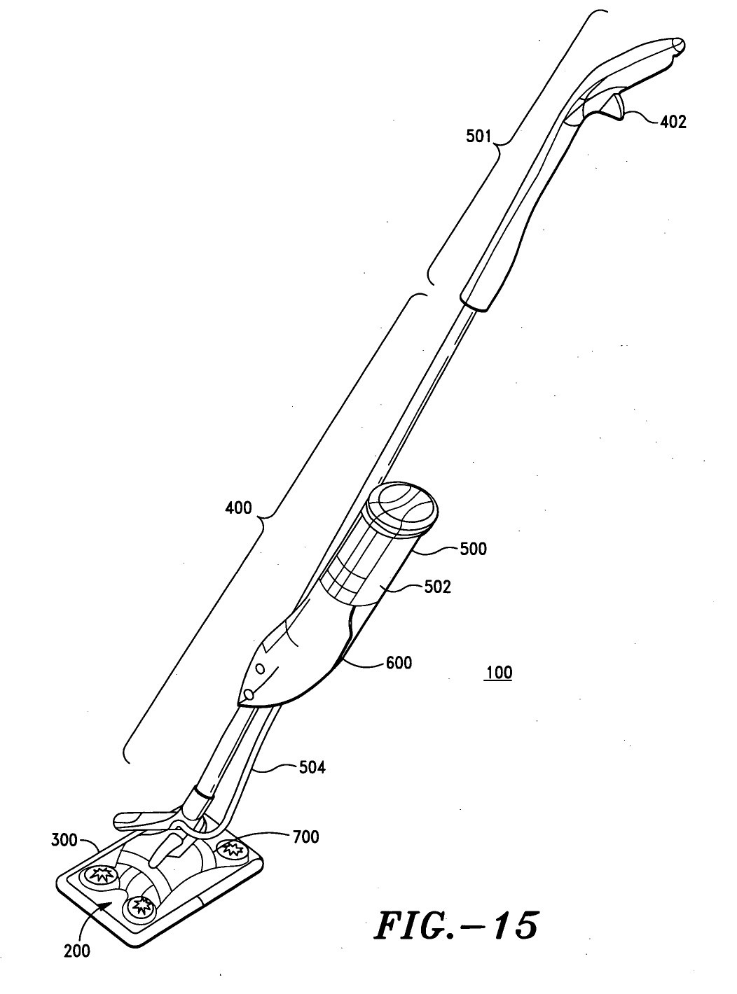

FIG. 15 is a representative view of a preferred embodiment of a fully assembled cleaning system 100 of the present invention. The cleaning tool 100 consists of a preferred embodiment of an absorbent cleaning pad or sheet 200, which is removably mounted onto a cleaning head assembly 300. The head sub-assembly 300 is coupled to a handle sub-assembly 400. The handle sub-assembly 400 can be disassembled for easy storage. A fluid reservoir 500 that is intended to carry a liquid cleaning solution 502 can be mounted on the handle sub-assembly 400 within a suitably designed holster sub-assembly 600. The fluid reservoir 500 has a flow delivery tube 504 which leads through a yoke portion on the handle sub-assembly to an fluid nozzle sub-assembly 700 which is mounted on the cleaning head sub-assembly 300 near the leading edge of the absorbent pad or sheet 200. A trigger mechanism 402 located on the proximal end 501 of the handle sub-assembly 400 actuates a valve system for providing flow of fluid from the fluid reservoir 500 through the nozzle sub-assembly 700.

In addition to the preferred embodiments, the reinforced handle may be used in a wide variety of tools, which must be both lightweight and durable. By way of example and not by limitation, a reinforced handle may be used with: toilet brushes or pads, glass-cleaning tools, painting tools such as brushes and rollers, gardening tools such as rakes and shovels, etc. It is important that each of these tools have a strong and lightweight handle because a user will have to carry the tool and be able to easily maneuver the tool along various surfaces at different angles depending on the task. In addition, some of these tools, such as a shovel, the handle must be able to withstand the pressure or torque the user applies the handle to scoop heavy items. A reinforced handle in a tool where the user must apply pressure or torque to the handle is critical to preserving the function and durability of the tool.

The strong and durable handle sub-assembly of the present invention utilizes a series of support ribs 568 and the insert material 554. The support ribs 568 and the insert material 554 make the handle lightweight and easy for a user to hold and maneuver, but still strong and sturdy to withstand any pressure exerted on the tool by the user. In addition, the use of support ribs 568 and insert material 554 add structural strength to the handle and uses less materials in manufacturing than a similar solid handle. The use of less materials in manufacturing than a similar solid handle makes the handle more cost effective to manufacture, ship and package. The insert material 554 is preferably designed to fit snugly in the spaces provided by the he support ribs 568 so that the two work together to provide the maximum amount of rigidity to the handle sub-assembly 400.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

We claim:

1. A reinforced handle comprising:
a) a handle housing with one or more support ribs positioned on the inside surface of the handle housing; and
b) a reinforcing insert positioned adjacent to the support ribs, wherein the reinforcing insert has a shape selected from one of the following group of an elongated bar with a U-shaped channel, a rod with a U-shaped channel, or a hollow cylinder.

2. The reinforced handle of claim 1 wherein the reinforcing insert comprises a metal.

3. The reinforced handle of claim 1 wherein the handle housing comprises a plastic.

4. The reinforced handle of claim 1 wherein one or more of the support ribs comprises a crisscross pattern.

5. The reinforced handle of claim 1 wherein said handle is attached to a cleaning assembly.

6. The reinforced handle of claim 5 further comprising a cleaning head assembly.

7. The reinforced handle of claim 1 wherein said handle is durable and able to withstand pressure and torque applied by a user.

8. The reinforced handle of claim 1 wherein said handle is attached to a tool selected from one of the following group: a toilet brush or pad, a glass cleaning tool, painting tool, a gardening tool.

9. A cleaning system with a reinforced handle comprising:
a) a handle housing having a proximal end and a distal end,
b) one or more support ribs positioned on an inside surface of the handle housing;
c) a reinforcing insert positioned adjacent to the support ribs; and
d) a cleaning head portion coupled to a shaft portion which is coupled to the distal end of the handle housing.

10. The cleaning system of claim 9 wherein the reinforcing insert comprises a metal.

11. The cleaning system of claim 9 wherein the reinforcing insert has a shape selected from one of the following group of an elongated bar with a U-shaped channel, a rod with a U-shaped channel, or a hollow cylinder.

12. The cleaning system of claim 9 wherein the reinforcing insert is adjacent to a push rod member which is coupled to a trigger member at the proximal end of the handle.

13. The cleaning system of claim 9 wherein the reinforcing insert is substantially straight.

14. The cleaning system of claim 9 wherein the distal end of the handle housing contains a sleeve member and the reinforcing insert is positioned above the sleeve member.

15. The cleaning system of claim 9 wherein the handle housing comprises a plastic.

16. The cleaning system of claim 9 wherein one or more of the support ribs are configured in a crisscross pattern.

17. The cleaning system of claim 9 wherein the proximal end of said handle portion comprises an ergonomic hand grip portion.

18. The cleaning system of claim 9 wherein the proximal end of said handle portion further comprises a hook member.

19. A handle for a cleaning system comprising:
a) a handle housing having a proximal end and a distal end,
b) a trigger member coupled to the handle housing at the proximal end;
c) a push rod positioned inside the handle housing and coupled to the trigger member; and
d) at least one reinforcing insert positioned approximately at the center of the handle housing, wherein the reinforcing insert substantially surrounds the push rod.

20. The handle of claim 19 wherein the reinforcing insert comprises a metal.

21. The handle of claim 19 wherein the reinforcing insert material has the shape selected from one of the following group of an elongated bar with a U-shaped channel, a rod with a U-shaped channel, or a cylinder.

22. The handle of claim 19 wherein the reinforcing insert material is positioned below an ergonomic hand grip portion which is at the proximal end of the handle housing.

23. The handle of claim 19 wherein the handle housing comprises a plastic.

24. The handle of claim 19 wherein an inside surface of the handle housing comprises support ribs.

25. The handle of claim 24 wherein one or more of the support ribs are configured in a crisscross pattern.

26. The handle of claim 19 wherein the proximate end of said handle housing further comprises a hook member.

27. The handle of claim 19 wherein said handle housing comprises one or more portions, which are removably attached by a mating means.

28. The handle of claim 19 wherein said handle housing further comprises one or more portions, permanently attached using one of the following: ultrasonic welding, overmolding, an adhesive, or combinations thereof.

29. A method for making a handle for a cleaning system comprising:
a) creating one or more handle housing portions;
b) inserting a trigger member connected to a push rod in between said handle housing portions;
c) inserting a reinforcing insert adjacent to said push rod;
d) joining said handle housing portions together.

30. The method of claim 29 wherein the handle housing portions comprise a right portion and a left portion.

31. The method of claim 29 wherein the handle housing portions are joined by using at least one of the following: ultrasonic welding, an adhesive, an overmold, or combinations thereof.
